(19) United States
(12) Patent Application Publication
(10) Pub. No.: US 2022/0375291 A1
(43) Pub. Date: Nov. 24, 2022

(54) SECURE LOCKING OF KEYLESS LOCK CONTROLLERS

(71) Applicant: SERA4 LTD., Waterloo (CA)

(72) Inventors: Jerod D. KLINK, Kitchener (CA); Daniel GALEANO, Toronto (CA)

(21) Appl. No.: 17/749,878

(22) Filed: May 20, 2022

Related U.S. Application Data
(60) Provisional application No. 63/191,275, filed on May 20, 2021.

(51) Int. Cl. G07C 9/22; G07C 9/27; G07C 9/00

(52) U.S. Cl. CPC G07C 9/22; G07C 9/27; G07C 9/00309; G07C 2009/00412; G07C 2009/00769; G07C 2209/62

(57) ABSTRACT

A lock control interface is operably connectable to an electrical actuator of a lock that restricts access to a physical resource. A primary wireless interface communicates with a wireless mobile device within a local vicinity of the primary wireless interface. A primary processor is connected to the primary wireless interface and the lock control interface. A secondary wireless interface communicates with a server via a long-range low-power wireless network. A secondary processor is connected to the secondary wireless interface. The secondary processor communicates with the server using the secondary wireless interface. The secondary processor is not operably connected to lock control interface. The primary processor controls the electrical actuator through the lock control interface to unlock the lock based on communication of cryptographic access data.

### CROSS-REFERENCE TO RELATED APPLICATION

This application claims the benefit of U.S. provisional application Ser. No. 63/191,275, filed May 20, 2021, which is incorporated herein by reference.

### BACKGROUND

Electronic locks are useful to protect physical assets, such as equipment, machinery, goods, valuables, and locations. Some electronic locks provide a keypad or other user interface to provide access. Other electronic locks are accessible by a smartphone or other wireless mobile device that may be carried by a person seeking to access the protected asset. This latter type of electronic lock is becoming more popular with the ever-increasing popularity of wireless mobile devices.

### BRIEF DESCRIPTION OF THE DRAWINGS

FIG. 1 is a schematic diagram of an example system including an electronic lock controller for providing local and/or remote secure access to a physical resource.

FIG. 2 is a block diagram of an example electronic lock controller for providing local and/or remote secure access to a physical resource.

FIG. 3 is a signal diagram showing an example operation of an electronic lock controller, in which both local and remote cryptographic access data are evaluated to unlock a lock.

FIG. 4 is a signal diagram showing an example operation of an electronic lock controller, in which a log is communicated to a remote server via a secondary subsystem.

FIG. 5 is a signal diagram showing an example operation of an electronic lock controller, in which either local or remote cryptographic access data is evaluated to unlock a lock.

FIG. 6 is a signal diagram showing an example operation of an electronic lock controller, in which local cryptographic access data is evaluated and remote authorization is required to unlock a lock.

FIGS. 7A and 7B are diagrams of an example electronic lock that prevents relocking without reconnection via an electronic lock controller, where FIG. 7A shows the lock prevented from relocking and FIG. 7B shows the lock free to relock.

FIG. 8 is a diagram of an example user interface that may be provided to a mobile device to facilitate user interaction with an electronic lock controller and lock thereof.

FIGS. 9A-9C are diagrams of example content of the user interface of FIG. 8 at different stages of interaction with an electronic lock controller that controls an electronic lock, such as that of FIGS. 7A and 7B.

FIG. 10 is a state diagram showing connection, unlocking, locking, and disconnection of a mobile wireless device and electronic lock controller.

### DETAILED DESCRIPTION

Electronic locks may store lock-access logs and may deliver such logs to a managing server, so that the person or organization that deployed the lock can fully understand who is accessing what physical assets/resources at what times. Logs may also relate maintenance or status information that may be useful to compile at the server, so that, for example, maintenance personnel can be dispatched efficiently.

Some types of electronic locks, particularly low-power locks that rely on batteries, take advantage of a user's internet connection to transmit log data. For example, a smartphone may be used to connect to an electronic lock to unlock the lock in a secure manner. While the lock may be manually lockable, the user may be expected to reconnect to the lock when finished accessing the guarded physical asset. This departing reconnection may be used to transmit a lock-access log to a server via the user's smartphone acting as a bridge to a larger network, such as the internet. However, it is often the case that the user forgets or otherwise fails to reconnect to the lock.

One solution is to use the initial connection between smartphone and lock, i.e., when the lock is unlocked, to transmit the log. However, this solution is insufficient as it results in an incomplete record of events because the expected locking of the lock has not yet occurred, is not yet logged, and thus cannot be transmitted. What happens in this scenario is that the next time the lock is opened, the log is transmitted and it is finally determined that the lock was locked at the end of the last visit after all. For infrequently accessed assets, the log stored at the server may be missing the most recent locking event for a significant amount of time, such as 1 week, 1 month, or longer. This may leave the organization or person responsible for the asset with the impression that the lock was never locked after the last visit. Or worse, the responsible party may get accustomed to ignoring missing locking events and thereby unknowingly leave their assets unguarded when the lock is truly not locked.

The present disclosure provides solutions to this problem. An electronic lock controller may be provided with a secondary subsystem that is connected to a long-range low-power network, which may include the internet, and the server that stores the logs. The secondary subsystem may be capable of transmitting logs at any suitable time. The secondary subsystem is isolated from the lock control functionality of the lock controller to prevent remote attacks against the primary subsystem that controls the lock. Another solution provided herein is a lock that cannot be relocked without reconnection to a smartphone with a user interface that encourages users to return to the lock prior to leaving the location of the guarded asset, so as to encourage the user to lock the lock when leaving the site and so that the log capturing this locking event may be transmitted to the server at the same time.

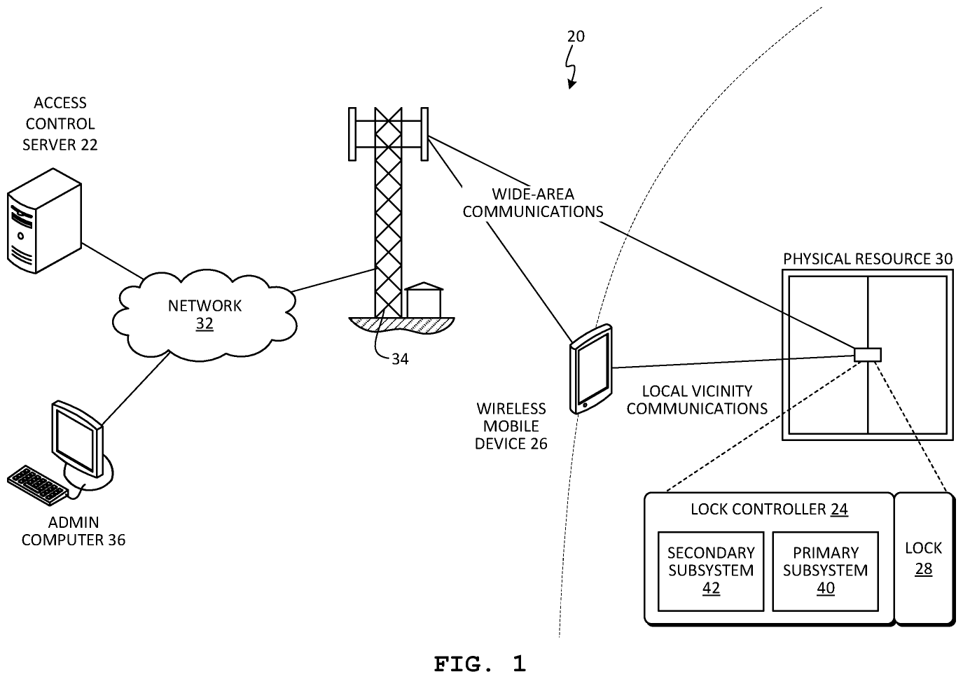

FIG. 1 depicts a system 20 for providing secure access to a physical resource. The system 20 includes a server 22, an electronic lock controller 24, and a plurality of wireless mobile devices 26. The lock controller 24 unlocks a physical lock 28 that restricts access to a physical resource 30. Unlocking is based on local access requests made by a wireless mobile device 26, which may be controlled by access permissions managed by the server 22, remote access requests from the server 22, or a combination of such. The system 20 may include any number of servers 22, electronic lock controllers 24, and wireless mobile devices 26 to restrict access to any number of physical resources 30. The electronic lock controller 24 may be contained within a housing, and the physical lock 28 may be incorporated into or onto the housing. Such a housing may be shaped as a padlock or similar.

The physical resources 30 guarded by the present invention may be situated at remote geographic locations. Examples of such resources include cell tower shacks, oilfield installations, construction equipment and sites, remote industrial facilities, and similar. The physical resources 30 guarded by the present invention may include industrial or commercial fixtures, such as storage cabinets, lockers, storerooms, yards, and similar. The present invention is particularly suited for physical resources that are normally accessed from one side (e.g., a shack that is not normally occupied, a cabinet, etc.). An example of a physical resource 30 is a cell tower shack that contains valuable equipment such as network devices and high-capacity batteries. That said, the preceding are merely examples of the types of physical resources 30 suitable for use with the present invention and they should not be taken as unduly limiting.

The wireless mobile devices 26 are configured to connect to the server 22 via a computer network 32. The computer network 32 includes one or more internet protocol (IP) networks, such as an intranet, a local-area network, a wide-area network, a virtual private network (VPN), a Wi-Fi network, the internet, and similar. Any suitable protocol, such as TLS and HTTPS, can be used for secure data communications. The computer network 32 can include cellular/mobile network infrastructure 34 that operates according to any type of cellular/mobile network technology and standard (e.g., 2G, 3G, 4G, GSM, UMTS/UTRA, HSPA, LTE, CDMA, WiMAX, etc.) that provides for relatively long-range wireless communications. Generally, the computer network 32 uses grid power and has wired components (e.g., Ethernet, fiber optics, etc.).

The server 22 may store cryptographic information, such as a public key and a corresponding private key. The keys may be generated according to any asymmetric cryptographic scheme or other cryptographic scheme. For example, NIST-approved elliptical curve cryptography may be used. The server 22 further stores a database that stores a plurality of user accounts for users of the wireless mobile devices 26 to be provided with secure access to physical resources 30. One or more administrator computers 36 may be provided to manage the server 22, and particularly manage the user accounts and which users have access to which physical resources 30 at what times.

Any suitable cryptographic scheme may be used, asymmetric, symmetric, or otherwise. The asymmetric scheme discussed herein in merely one example.

The lock controller 24 may store a digital certificate that includes a public key and a corresponding private key for the particular lock 28. Each lock controller 24 may have its own unique digital certificate. The public and private keys of the lock controller 24 accord to the selected asymmetric cryptographic scheme. Keys of any suitable bit length (e.g., 64-bit, 228-bit, 256-bit, etc.) may be employed based on the desired level of security. In addition, the digital certificate has been previously digitally signed by the private key of the server 22. Signing of the digital certificate with the private key of the server 22 is preferably done in a secure environment, such as at a factory that manufactures lock controllers and provisions servers. The lock controller 24 further stores the public key of the server.

The wireless mobile devices 26 are carried by users who are to be granted access to the physical resource 30 and/or who are to provide maintenance to the lock 28 and/or lock controller 24. Access permissions are associated with user accounts in the database at the server 22. A user logs into his/her account, using for example a unique username and password, from their wireless mobile device 26 to obtain from the server 22 cryptographic access data that grants access to the physical resource 30, grants maintenance permission, or grants another permission.

The wireless mobile device 26 and electronic lock controller 24 may be configured to mutually connect for data communications when within local vicinity of each other. That is, each of the wireless mobile devices 26 and the electronic lock controller 24 has a local-range communications interface, which can include a chipset and/or antenna/transceiver operable according to any suitable short-range wireless communications scheme (e.g., Bluetooth, Bluetooth Smart, Bluetooth Low Energy or BLE, Wi-Fi, ZigBee, Google Thread, Near Field Communication or NFC, etc.), short-range audio communications scheme, short-range infrared communications scheme, or similar technology. The particular short-range communications scheme selected is not specifically limited, though its range is shorter than that provided by the computer network 32. However, because the present invention concerns granting physical access to remote physical resources that may not have access to grid power, it is contemplated that shorter-ranged schemes will generally be more advantageous due to reduced power consumption. The presently preferred short-range communications schemes include Bluetooth and BLE.

Alternatively, the wireless mobile device 26 and electronic lock controller 24 are configured to mutually connect for data communications over the computer network 32 (e.g., over the internet).

Unlocking and/or locking of the lock 28 using the lock controller 24 may be performed in an authorized manner by a particular wireless mobile device 26 on the basis of the certificates and keys discussed above.

The electronic lock controller 24 includes a primary subsystem 40 and a secondary subsystem 42. The primary subsystem 40 includes a short-range wireless interface and is operatively connected to the lock 28 to control unlocking the lock 28. The secondary subsystem 42 includes a long-range wireless interface and is not operatively connected to the lock 28 and, instead, is operatively connected to the primary subsystem 40. As such, the secondary subsystem 42 may be used in unlocking the lock 28 and may have its control of the unlocking of the lock 28 under the governance of the primary subsystem 40. In various examples, as will be discussed below, the primary subsystem 40 may locally connect to a wireless mobile device 26 to communicate cryptographic access data to facilitate unlocking the lock 28, while the secondary subsystem 42 may connect to the access control server 22 to independently or dependently communicate cryptographic access data to facilitate unlocking the lock 28. For example, in an independent methodology, either the primary subsystem 40 or the secondary subsystem 42 may open the lock 28. That is, a user may attend to the location of the lock 28, present valid cryptographic access data, and the primary subsystem 40 may open the lock 28, while a remote user at an administrator computer 36 may connect to the secondary subsystem 42 to remotely open the lock 28. In an example dependent methodology, a remote user at an administrator computer 36 may make a request to the secondary subsystem 42 to unlock the lock 28 and that request is not acted upon unless a local user presents valid cryptographic access data to the primary subsystem 40.

In various examples, the primary subsystem 40 is incapable of connecting to the network 32 unless such connection is facilitated by a wireless mobile device 26. At the same time, the primary subsystem 40 is operably connected to the lock 28. As such, the primary subsystem 40 requires local presence to open the lock 28. In contrast, the secondary subsystem 42 may connect to the network 32 and the server 22 via the infrastructure 34, but does not have a direct operable connection to the lock 28. Rather, the secondary subsystem 42 may be limited to communicate with the lock 28 through the primary subsystem 40, which may enforce a local presence for remote access to the lock 28.

The wireless mobile device 26 may include a network interface, a wireless interface, a user interface, memory, and a processor. The wireless mobile device 26 may further include a global positioning system (GPS) device and a camera. The network interface is configured for bidirectional data communications via the computer network 32. The network interface includes a network adaptor and driver suitable for the type of network 32. The wireless interface includes a short-range communications interface, such those discussed above (e.g., Bluetooth, BLE, etc.). The network interface and the wireless interface may be the same interface configured differently. The user interface includes a display device, a touchscreen, a keyboard, a microphone, a speaker, or a combination of such. The memory includes any combination of read-only memory (ROM), random-access memory (RAM), flash memory, flash memory, magnetic storage, optical storage, and similar for storing instructions and data as discussed herein. The processor includes one or more central-processing units (CPUs), microcontrollers, microprocessors, processing cores, field-programmable gate arrays (FPGAs), and similar. All or some of the memory may be integrated with the processor. The processor and memory cooperate to execute instructions to cause the wireless mobile device 26 to perform the functionality discussed herein. The wireless mobile device 26 executes a mobile application that performs some or all of the relevant the functionality discussed herein.

The server 22 may include a network interface, memory, and a processor. The network interface is configured for bidirectional data communications through the computer network 32. The network interface includes a network adaptor and driver suitable for the type of network 32. The memory includes any combination of ROM, RAM, flash memory, magnetic storage, optical storage, and similar for storing instructions and data as discussed herein. The processor includes one or more CPUs, microcontrollers, microprocessors, processing cores, FPGAs, and similar. All or some of the memory may be integrated with the processor. The processor and memory cooperate to execute instructions to cause the server to perform the functionality discussed herein. The term server as used herein refers to a single server or multiple cooperating servers. The server 22 includes a server application that performs some or all of the relevant functionality discussed herein.

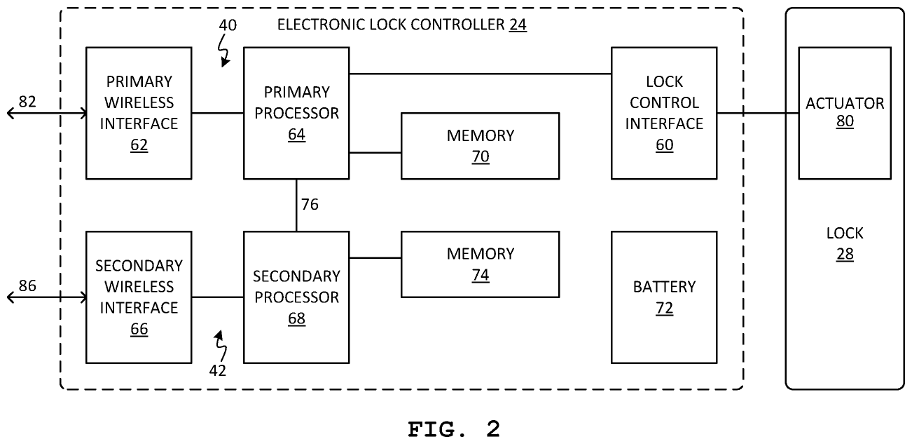

FIG. 2 shows a block diagram of an example electronic lock controller 24 that may be used with the system 20.

The electronic lock controller 24 includes a lock control interface 60, a primary wireless interface 62, a primary processor 64, secondary wireless interface 66, secondary processor 68, and memory 70, 74. The lock controller 24 may further include a battery 72 or other power supply, such as a wired connector to connect to mains power, and a housing to contain the components of the lock controller 24.

The lock control interface 60 is operably connectable to an electrical actuator 80 of a lock 28 that restricts access to a physical resource. The lock control interface 60 may include an output interface or an input/output (I/O) interface. The lock control interface 60 is configured to send a signal to the actuator 80 to unlock the lock 28. Alternatively, the lock control interface 60 may also be configured to send a signal to the actuator 80 to lock the lock 28. The lock control interface 60 may also be configured to receive a status signal from the actuator 80 that indicates whether the lock is unlocked or locked. In various examples, the lock control interface 60 also provides power to the actuator 80.

In this example, the lock 28 includes driving circuitry and an electrical actuator 80 such as motor, solenoid, or similar device that converts electrical power into mechanical movement of the lock 28 according to a signal received from the lock control interface 60.

The primary wireless interface 62 is configured for communication 82 with a wireless mobile device (e.g., device 26 of FIG. 1) that is within a local vicinity of the primary wireless interface 62. The primary wireless interface 62 may include a short-range communications interface, such those discussed above (e.g., Bluetooth, BLE, etc.).

The primary processor 64 is connected to the primary wireless interface 62 and the lock control interface 60. The primary processor 64 is configured to control the electrical actuator 80 through the lock control interface 60 to unlock the lock based on communication 82 of cryptographic access data with a wireless mobile device via the primary wireless interface 62. The wireless mobile device may bridge communications 82 to a larger network, such as a cellular network. The primary processor 64 includes a CPU, microcontroller, microprocessor, processing core, FPGA, or similar processor.

The primary processor 64 is connected to the memory 70, The primary processor 64 is provided with the necessary cryptographic data, which may be stored in the memory 70, to authenticate a request to unlock the lock 28 received through the primary wireless interface 62.

The primary processor 64 and primary wireless interface 62 may together be referred to as a primary subsystem 40, as discussed above with respect to FIG. 1. The memory 70 may be considered part of the primary subsystem 40.

The secondary wireless interface 66 is configured for communication 86 with a server (e.g., server 22 of FIG. 1) via a long-range low-power wireless network, such as those discussed above (e.g., a 2G network, a 3G network, a CDMA network, etc.). The secondary wireless interface 66 provides a significantly longer range of communications 86 compared to communications 82 provided by the primary wireless interface 62. The secondary wireless interface 66 may provide communications 66 over a distance on the order of kilometers, which may be a distance to a cell tower or the like, while the primary wireless interface 62 may be limited to communications 82 within a range on the order of meters (e.g., 10 meters or 100 meters).

The secondary processor 68 includes a CPU, microcontroller, microprocessor, processing core, FPGA, or similar processor. The secondary processor 68 is connected to the secondary wireless interface 66. The secondary processor 68 is configured for communication 86 with the server using the secondary wireless interface 86. The secondary processor 68 is not operably connected to lock control interface 60. In other words, the secondary processor 68 is isolated from the lock control interface 60. This may include a physical or hardware-level isolation, in which the secondary processor 68 does not have a direct physical signal-bearing connection to the lock control interface 60.

The secondary processor 68 is connected to memory 74 that is separate from the memory 70 of the primary processor 64. Alternatively, the memory 70, 74 may be a shared memory useable by both processors 64, 68.

The secondary processor 68 is limited to communications functionality and the primary processor 66 is provided with the necessary cryptographic data to authenticate a request to unlock the lock 28 received through the secondary wireless interface 86. That is, the secondary processor 68 is limited to communications functionality with the secondary wireless interface 66 and the primary processor 64. The communications functionality of the secondary processor 68 may be governed by a protocol enforced by the primary processor 64. All decisions regarding the lock control interface 60 are made by the primary processor 64. As such, even if the secondary processor 68 is compromised, it cannot be used to command the lock control interface 60 to unlock the lock 28. At worst, the secondary processor 68 may be used to provide forged or unauthorized requests or cryptographic access data to the primary processor 64. When the primary processor 64 is properly configured, it can deny requests and cryptographic access data that are improper.

The secondary processor 68 and secondary wireless interface 66 may together be referred to as a secondary subsystem 42, as discussed above with respect to FIG. 1. The memory 74 may be considered part of the secondary subsystem 42.

The memory 70, 74 includes any combination of ROM, RAM, flash memory, magnetic storage, optical storage, and similar for storing instructions and data as discussed herein. Memory 70, 74 may be integrated within the respective processor 64, 68.

The primary and secondary processors 64, 68 may communicate using any suitable scheme. For example, primary and secondary processors 64, 68 may be connected by an interface 76, such as an I2C bus. In another example, the primary and secondary processors 64, 68 may be configured to read from and write to shared portion of common memory 70, 74. As such, the processors 64, 68 may communicate information by reading from and writing to shared memory 70, 74. In another example, a processor 64, 68 may have an output pin that is connected to an input pin of the other processor 64, 68. As such, the processor 64, 68 may output a signal at its output pin and the other processor 64, 68 may capture the signal at its input pin.

The battery 72 may be a rechargeable battery that is configured to provide power to the electronic lock controller 24 and, optionally, the lock 28, as needed. For sake of explanation, the term “battery” is used herein to denote an electrochemical cell, group of cells, or similar. The battery 72 may be internal or external to the electronic lock controller 24. In other examples, one or both of the electronic lock controller 24 and the lock are powered by wall or mains power.

In operation, the primary processor 64 controls the electrical actuator 80 through the lock control interface 60 to unlock the lock 28 based on communication of cryptographic access data. As will be discussed further below, cryptographic access data may be received via a communication 82 from a wireless mobile device near the electronic lock controller 24 or via a communication 86 from a server that is remote to the electronic lock controller 24. In various examples, and request to unlock the lock 28 made by a server that is remote to the electronic lock controller 24 is acted on if and only if valid cryptographic access data is provided wireless mobile device near the electronic lock controller 24. This allows remote opening of the lock 28 as long as local presence has been established. In various examples, logs that record accesses and attempted accesses to the lock 28 may be communicated 82 to a nearby wireless mobile device for subsequent communication to the remote server via the wireless mobile device's long-range connection. Additionally or alternatively, logs may be communicated directly to the server as a communication 86, which may be useful when a user carrying a wireless mobile device leaves the location of the lock 28 without again connecting to the electronic lock controller 24.

Cryptographic access data may include encrypted data that is decrypted by the primary processor 64 using a corresponding key stored in memory 70, where successful decryption allows unlocking the lock 28.

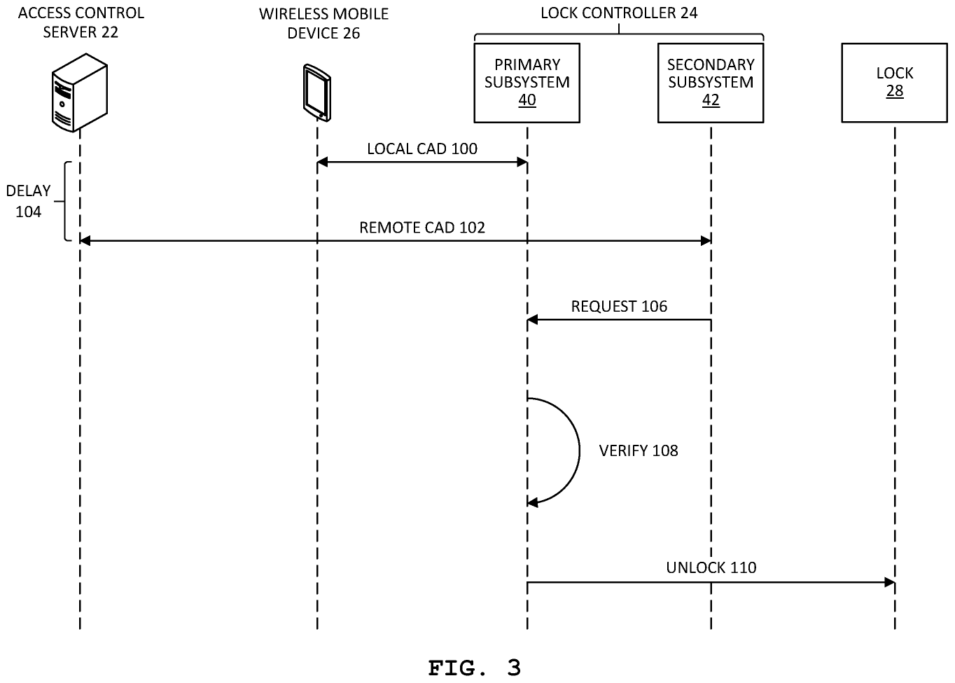

Various example operations will be described with regard to FIGS. 3-6. It should be understood that these example operations may be implemented by process-executable instructions stored at and executed by the lock controller 24, wireless mobile device 26, and/or the server 22.

FIG. 3 shows an example of operation of a lock controller 24, as shown in FIG. 2. In this example, the verification of access data presented by both a locally present wireless mobile device and a remote server is required to open the lock.

The primary subsystem 40 communicates, via its short-range wireless interface, local cryptographic access data (“CAD”) 100 with a wireless mobile device 26 that is in local vicinity to the lock controller 24. Either the primary subsystem 40 or the wireless mobile device 26 may initiate the communication. The communication may be unidirectional or bidirectional (as shown). The communication of cryptographic access data 100 allows the primary processor of the primary subsystem 40 to verify that the user of the wireless mobile device 26 is authorized to unlock the lock 28. An example of communication of cryptographic access data 100 is described in U.S. Pat. No. 11,049,341, which is incorporated herein by reference.

The secondary subsystem 42 communicates, via its long-range wireless interface, remote cryptographic access data 102 with a server 22 that is remote from the lock controller 24. Either the secondary subsystem 42 or the server 22 may initiate the communication. The communication may be unidirectional or bidirectional (as shown). The communication of cryptographic access data 102 allows the secondary processor of the secondary subsystem 42 to indicate that the organization in control of the server 22 wishes to unlock the lock 28. The teachings of U.S. Pat. No. 11,049,341 may be adapted to implement the communication 102 of remote cryptographic access data 102.

The communications of cryptographic access data 100, 102 may be allowed to occur in any order or may be enforced to only occur in one order, such as the order shown in which the local cryptographic access data 100 is received before the remote cryptographic access data 102 or the opposite order. A delay 104 may be allowed between receiving the communications of cryptographic access data 100, 102. If the communications of cryptographic access data 100, 102 are received a duration apart that is greater than the allowed delay 104, then unlocking of the lock 28 may be denied. Example delays 104 include 1 minute, 5 minutes, 20 minutes, 1 hour, and 1 day. This may be useful in various scenarios. For example, an administrator at an admin computer 36 (FIG. 1) may cause the server 22 to communicate the remote cryptographic access data 102 with the lock controller 24 to grant access to unlock the lock 28 in advance of a local user who is expected to arrive at the site guarded by the lock 28 within the delay 104. When the local user controls their wireless mobile device 26 to communicate the local cryptographic access data 100 with the lock controller 24, provided that the delay 104 has not elapsed, then lock 28 can be unlocked. In another example, the local user arrives at the site and performs the communication of local cryptographic access data 100, then calls or messages the remote administrator to carry out the communication of remote cryptographic access data 102. In this case, the delay allows the administrator time to perform the needed actions. In various scenarios, the remote cryptographic access data 102 may be considered a second factor of security that is valid for a certain period that is defined by the delay 104.

In response to successful communication of the remote cryptographic access data 102, the secondary subsystem 42 sends a request 106 to unlock the lock 28 to the primary subsystem 40. The secondary subsystem 42 acts as a communications conduit, so the request 106 contains the remote cryptographic access data 102 for verification by the primary subsystem 40.

The primary subsystem 40 verifies 108 the local cryptographic access data 100 using a cryptographic technique suitable for the cryptography scheme used. The primary subsystem 40 also verifies the remote cryptographic access data 102 whether by applying a cryptographic technique to the remote cryptographic access data 102 provided with the request 106. The cryptographic techniques for the local cryptographic access data 100 and the remote cryptographic access data 102 may be the same or different.

If both cryptographic access data 100, 102 are verified successfully, the primary subsystem 40 transmits an unlock signal 110 the lock 28 in response. The lock 28 then unlocks to allow physical access to the protected asset to the user in possession of the wireless mobile device 26.

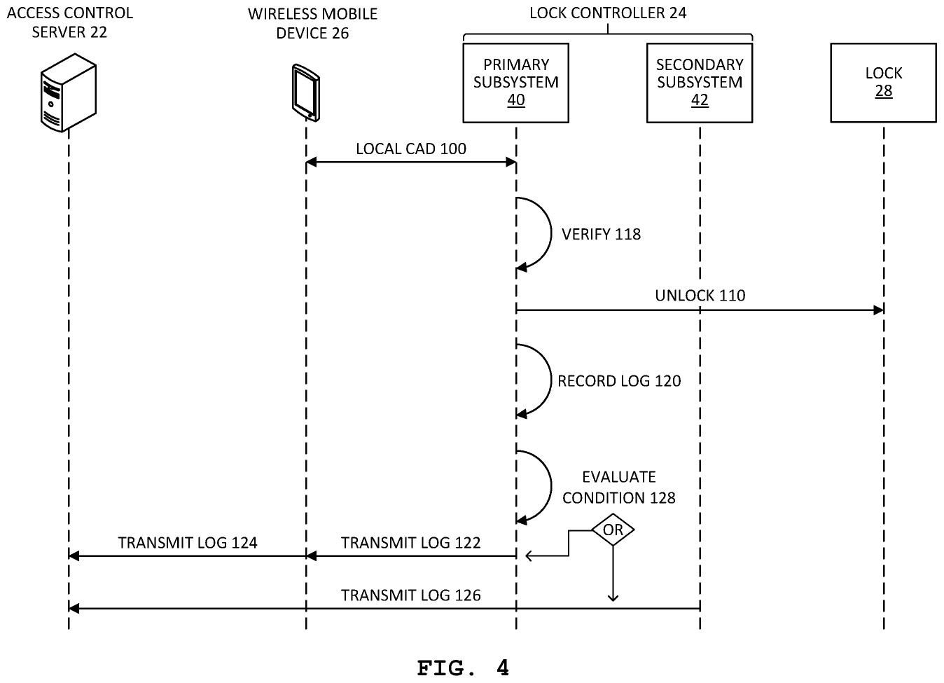

FIG. 4 shows an example of operation of a lock controller 24, as shown in FIG. 2. In this example, the verification of access data presented by a locally present wireless mobile device is required to open the lock and an isolated secondary subsystem may be used to communicate a lock-access log to a server.

The primary subsystem 40 communicates, via its short-range wireless interface, local cryptographic access data 100 with a wireless mobile device 26 that is in local vicinity to the lock controller 24. The primary subsystem 40 verifies 118 the local cryptographic access data 100 using a cryptographic technique suitable for the cryptography scheme used. If the cryptographic access data 100 is verified successfully, in response, the primary subsystem 40 transmits an unlock signal 110 the lock 28. Further detail is provided above.

The primary subsystem 40 records 120 the lock unlocking event to a lock-access log. The lock-access log may be indicative of the lock controller 24 unlocking the lock 28 in response to any number of instances of successful communication of local cryptographic access data 100 with any number of different wireless mobile devices 26. The lock-access log may also store failed attempts to gain access, maintenance data (such as batter level), and other events relevant to the operation of the lock controller 24 and lock 28.

If, at a later time, the same or different wireless mobile device 26 connects to the lock controller 24, then the primary subsystem 40 may transmit 122 the log to the wireless mobile device 26, which in turn transmits 124 the log to the server 22. The wireless mobile device 26 may be used as a bridge to a long-range low-power network to which the server 22 is connected. This may occur if the same user connects their wireless mobile device 26 to the lock controller 24 before leaving the site. This may also occur the next time the same user or a different user attends to the site with their wireless mobile device 26 to gain access via the lock controller 24.

If a wireless mobile device 26 is not available to transmit 122 the log, then the secondary subsystem 42 may use its long-range wireless interface to directly transmit 126 the log to the server 22. Alternatively, bridging by the wireless mobile device 26 may be avoided and the secondary subsystem 42 may be used exclusively to transmit log data to the server 22.

In cases where logs may be transmitted both ways, whether the wireless mobile device 26 is unavailable to transmit 122 the log may be determined by a condition 128, such as age of the log, battery life, or some other condition that represents a need to transmit 126 the log directly to the server 22 with the secondary subsystem 42 that justifies the power usage. For example, the primary subsystem 40 may periodically check whether an uncommunicated log has an oldest timestamp that is older than an allowable age (e.g., 1 week). If the log is not yet that old, then the primary subsystem 40 may await the connection of a wireless mobile device 26. If the log is that old, then the primary subsystem 40 may instruct the secondary subsystem 42 to transmit the log directly to the server 22.

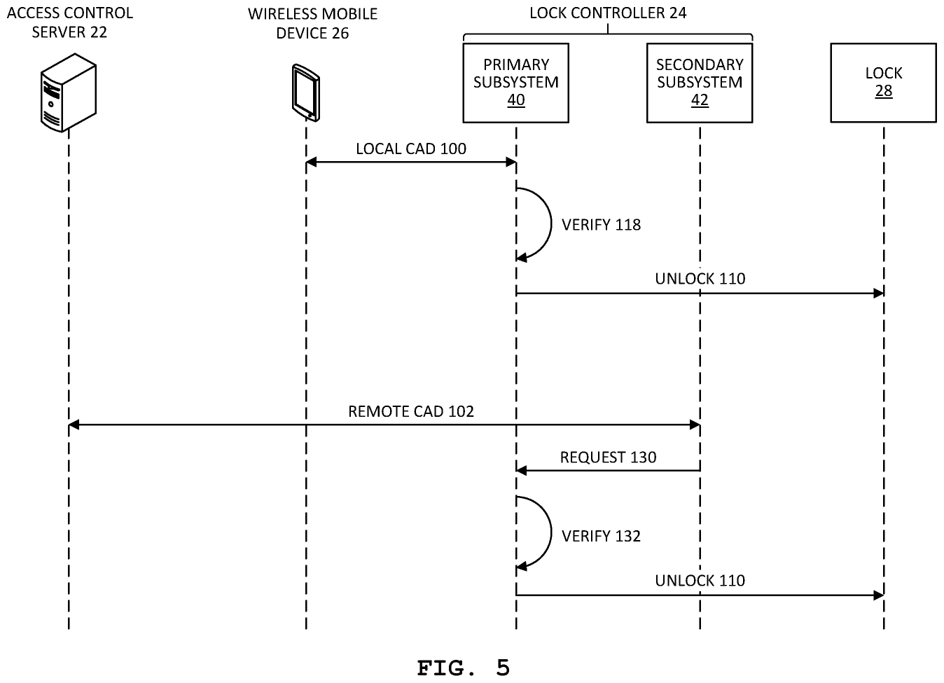

FIG. 5 shows an example of operation of a lock controller 24, as shown in FIG. 2. In this example, the verification of access data presented by either a locally present wireless mobile device or a remote server is required to open the lock.

The primary subsystem 40 communicates, via its short-range wireless interface, local cryptographic access data 100 with a wireless mobile device 26 that is in local vicinity to the lock controller 24. The primary subsystem 40 verifies 118 the local cryptographic access data 100 using a cryptographic technique suitable for the cryptography scheme used. If the cryptographic access data 100 is verified successfully, in response, the primary subsystem 40 transmits an unlock signal 110 the lock 28. Further detail is provided above.

Independently of local access, access may be granted remotely. The secondary subsystem 42 communicates, via its long-range wireless interface, remote cryptographic access data 102 with a server 22 that is remote from the lock controller 24. The secondary subsystem 42 then makes a request 130 to the primary subsystem 40. The request 130 contains the remote cryptographic access data 102 for verification by the primary subsystem 40. The primary subsystem 40 verifies 132 the remote cryptographic access data 102 received with the request 130 using a cryptographic technique suitable for the cryptography scheme used. If the cryptographic access data 102 is verified successfully, in response, the primary subsystem 40 transmits an unlock signal 110 the lock 28.

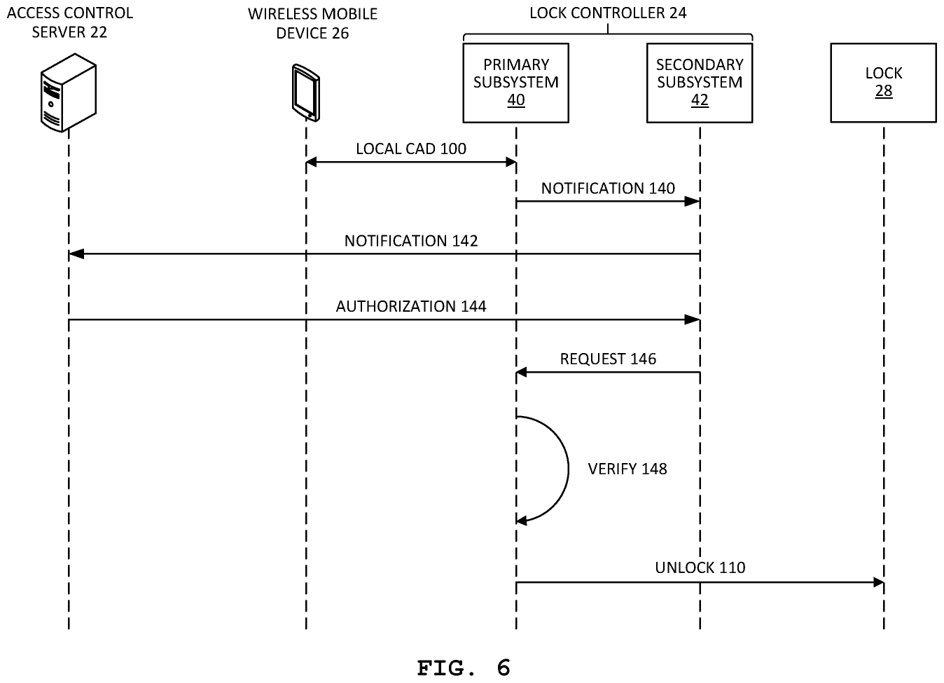

FIG. 6 shows an example of operation of a lock controller 24, as shown in FIG. 2. In this example, the verification of access data presented by a locally present wireless mobile device and remote authorization is required to unlock a lock. This example is similar to that of FIG. 3, with the delay replaced by notification and authorization communications.

The primary subsystem 40 communicates, via its short-range wireless interface, local cryptographic access data 100 with a wireless mobile device 26 that is in local vicinity to the lock controller 24, as discussed above.

During or after the local communication 100, the primary subsystem 40 notifies 140 the secondary subsystem 42 of the attempted access and, in response, the secondary subsystem 42 uses its long-range wireless interface to transmit a corresponding notification 142 to the server 22. The notification 142 is indicative to the server 22 of the wireless mobile device 26 being within a local vicinity of the short-range interface. The notification 142 may contain identity information, such as a user ID, of the user attempting access.

The server 22 or an administrator thereof may allow or deny the requested access. As such, in response to the notification 142, the server 22 may transmit an authorization 144 to the secondary subsystem 42 via the long-range wireless network.

The secondary subsystem 42, in response to receiving the authorization 144, may transmit to the primary subsystem 40 a request 146 to unlock the lock 28. In this example, the request 146 does not contain cryptographic access data. In other examples, the request does contain remote cryptographic access data, similar to the examples of FIGS. 3 and 5.

The primary subsystem 40 may verify 148 that the communication of local cryptographic access data 100 was successful and that the request 146 indicative of the remote authorization was received. The primary subsystem 40 also verifies remote cryptographic access data provided with the request 146, if that option is implemented. In response to successful verification, the primary subsystem 40 may transmit an unlock signal 110 the lock 28.

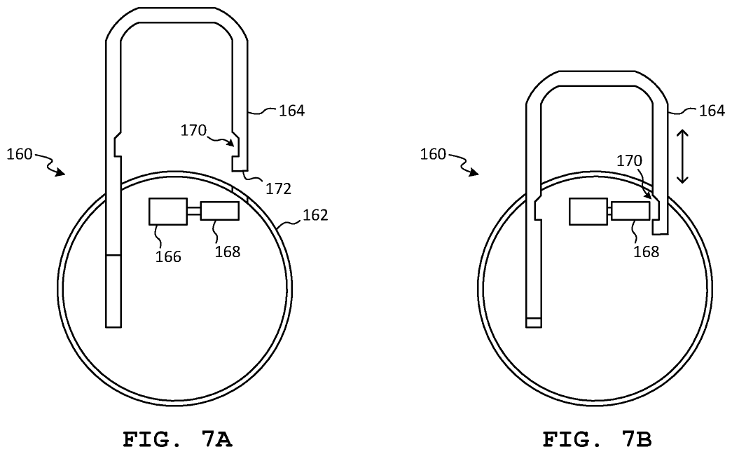

FIGS. 7A and 7B show an example electronic lock 160 that prevents relocking without reconnection via an electronic lock controller, where FIG. 7A shows the lock prevented from relocking and FIG. 7B shows the lock free to relock. The electronic lock 160 is an example of the electronic lock 28 of FIGS. 1 and 2.

The lock includes a body 162 and shackle 164 moveable with respect to the body 162 and having and end 172 that can be inserted into and removed from the body 162.

Inside the body 162 is an actuator 166, such as a solenoid or motor, and a latching piece 168 that is moved by the actuator 166. The actuator 166 may be connected to an electronic lock controller, such as the controller 24 of FIGS. 1 and 2. In this sense, the actuator 166 is comparable to the actuator 80 of FIGS. 1 and 2.

The latching piece 168 may be positioned to engage with a recess 170 in near the end 172 of the shackle 164 to lock the lock 160 when the shackle 164 is closed. The same position of the latching piece 168 may prevent the shackle 164 from being closed, as depicted in FIG. 7A, because passage of the end 172 is blocked by the latching piece 168.

The latching piece 168 may be positioned to disengage from the recess 170 to unlock the lock 160. The same position of the latching piece 168 may allow the shackle 164 to be freely moved into and out of the body 162, as depicted in FIG. 7B.

The position of the latching piece 168 is controlled by the actuator 166 which is controlled by the lock controller. As such, the lock 160 may be unlocked, locked, and prevented from closing and thus locking, as shown in FIG. 7A.

In an alternative example, the state of the lock 160 shown in FIG. 7B prevents the lock from being locked by preventing the actuator 166 from being actuated. The actuator 166 may be moved, physically blocked, or deactivated by a lock controller to achieve this.

The lock 160 is merely one example of a lock that prevents relocking by manual action only. Other examples are contemplated, such as an electric deadbolt integrated into a door. The deadbolt may be electrically actuated to its extended position after the door is opened, so as to obstruct complete closing of the door and prevent manual relocking of the lock.

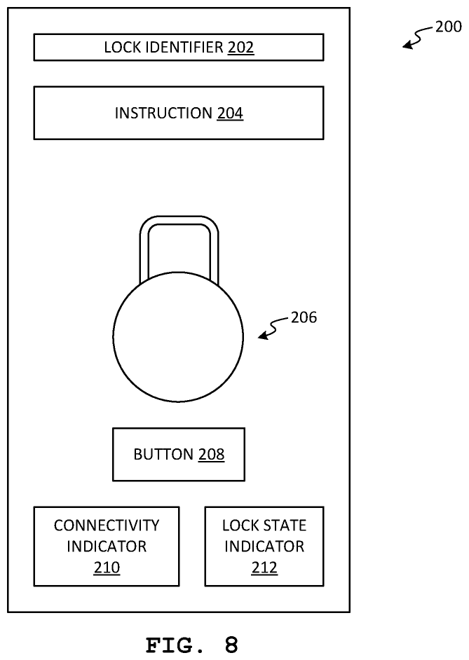

FIG. 8 shows example user interface 200 that may be provided to a wireless mobile device, such as a wireless mobile device 26 of FIG. 1, to facilitate user interaction with an electronic lock controller and lock thereof, such as the controller 24 and lock 28 of FIGS. 1 and 2.

The user interface 200 may be provided as instructions executable by a processor of the wireless mobile device. The user interface 200 may be provided to a touchscreen of the wireless mobile device and may control or operate with the short-range wireless connection functionality of the wireless mobile device with an electronic lock controller.

The user interface 200 includes a lock identifier 202, an instruction 204, an image 206, a button 208, a wireless connectivity indicator 210, and a lock state indicator 212.

The lock identifier 202 indicates a name or identifier of the lock controller to which the wireless mobile device is connected.

The instruction 204 displays an instruction, such as a sentence, to the user for operation of the lock controller.

The image 206 visually indicates the state of the lock, such as whether it is locked or unlocked.

The button 208 is an activatable element that the user may activate, such as by touching, to issue a command to the wireless mobile device related to operation of the lock controller and lock thereof.

The wireless connectivity indicator 210 indicates a degree of connectivity with the short-range wireless interface of the lock controller.

The lock state indicator 212 may include a text representation of the lock state, such as locked or unlocked, to supplement the image 206.

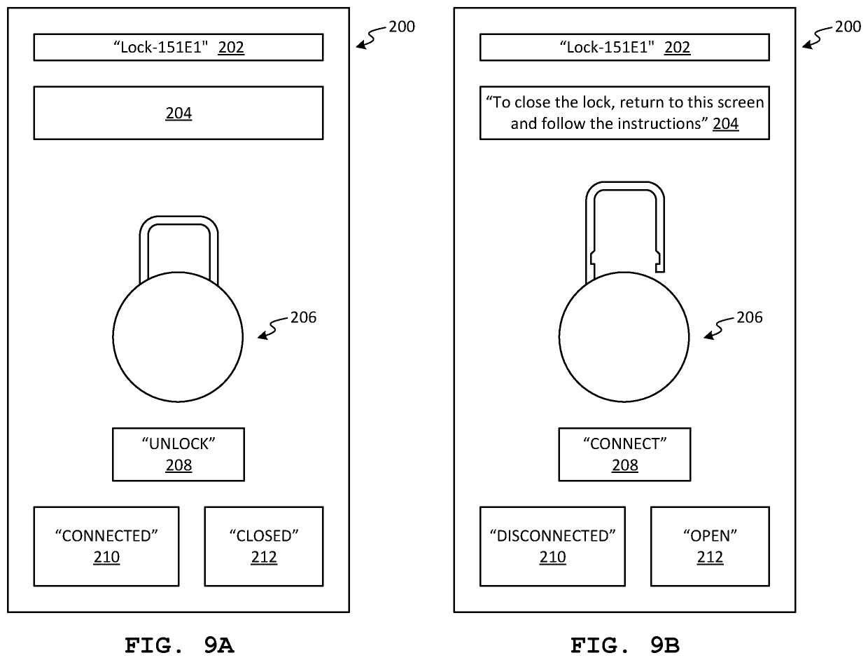

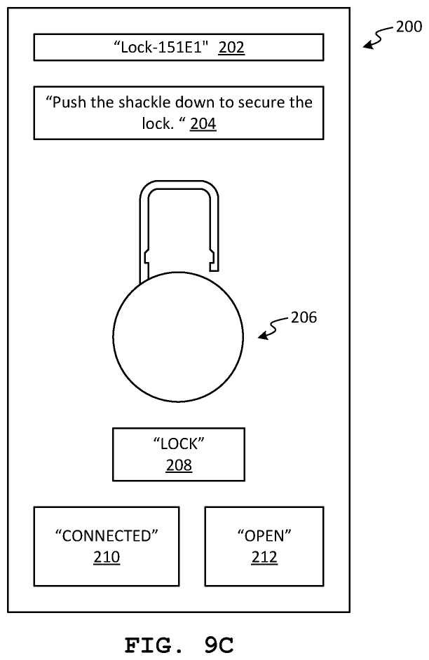

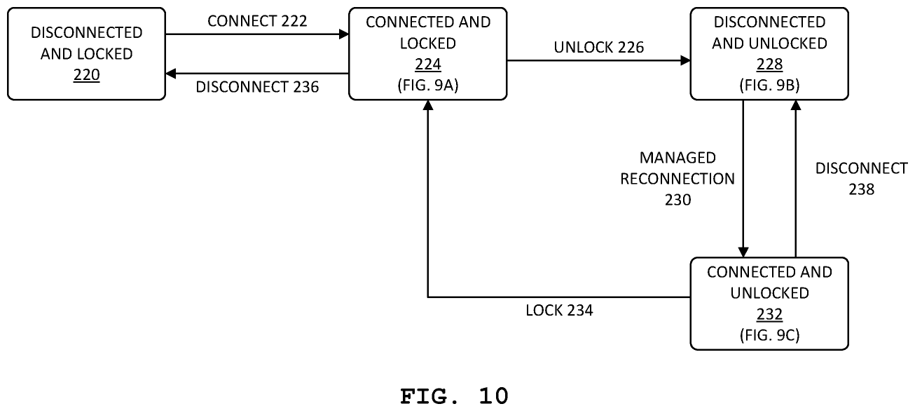

FIG. 9A shows the user interface 200 when initially connected to an electronic lock controller, such as the lock controller 24 of FIGS. 1 and 2. The lock identifier 202 indicates the specific lock connected, the wireless connectivity indicator 210 indicates that the connection is active, and the lock state indicator 212 and image 206 indicate the status of the lock as closed. The button 208 informs the user that the lock may be unlocked by pressing it. The communication of local cryptographic access data 100 and verification 108, 118, 146 (FIGS. 3-6) has already been completed by this point or will be completed once the user presses the button 208.

FIG. 9B shows the user interface 200 after the button 208 is pressed to unlock the lock, i.e., after the state shown in FIG. 9A. The communication of local cryptographic access data 100 and verification 108, 118, 146 (FIGS. 3-6), whether performed before the button press or in response thereto, is determined to be successful and the lock is unlocked and opened. The lock state indicator 212 and image 206 indicate the status of open. Further, the connection between the wireless mobile device and lock controller is ended and the wireless connectivity indicator 210 indicates such. The instruction 204 displays a reminder to the user to return to the user interface 200 to reconnect to the lock controller. The button 208 now triggers reconnection to the lock controller and indicates same. The lock itself may be at a state shown in FIG. 7A, in which relocking is physically prevented.

FIG. 9C shows the user interface 200 when the user returns. This state of the user interface 200 may be triggered by the user reopening the application, the user waking their smartphone, a timer elapsing, or a combination of such. The information and instruction of FIG. 9B should persist so that the user has time to understand. Further, the information and instruction of FIG. 9B should persist to prevent the user from improperly locking the lock immediately after opening it. The user interface 200 in the state of FIG. 9C shows a lock state indicator 212 that indicates that the lock controller is ready to function, provides an instruction 204 to the user to manually close the lock (if necessitated by the type of lock), and provides a button 208 that commands the lock controller to lock the lock. The user is thus informed of the correct locking procedure. The user may then manually place the lock in the state shown in FIG. 7B and then press the button 208 to engage the latching piece 168 with the recess 170 at the shackle 164. It should be noted that locking the lock may also include the communication of cryptographic access data and verification (FIGS. 3-6).

The state of the user interface 200 at FIG. 9C encourages reconnection of the wireless mobile device to the lock controller. This may facilitate transmission of a complete log to the server, where such log also captures the final closing event provided for by the state of the user interface 200 at FIG. 9C.

FIG. 10 summarizes the states discussed above.

An initial state 220 of the lock is locked and disconnected from a wireless mobile device. When a user arrives at the location of the lock, they may connect 222 their wireless mobile device to the lock via a short-range wireless interface. Connection may be triggered by the user opening the application or it may be automatic.

Initial connection 222 sets a connected and locked state 224, an example of which is shown in FIG. 9A. The wireless mobile device and lock controller are wirelessly connected and capable of communication in this state 224. The user may now command the lock to unlock 226 provided that the exchange of cryptographic information is successful.

The unlock 226 transition results in a disconnected and unlocked state 228, an example of which is shown in FIG. 9B. The physical asset may now be accessed by the user. The lock may be prevented from being relocked by manual action (FIG. 7A).

A managed connection 230 transitions from the disconnected and unlocked state 228 to a connected and unlocked state 232. Examples of managed connections 230 include the elapsing of a timer (e.g., a 30-second, 1-minute, 5-minute, or 30-minute timer) or a user action, such as returning to a user interface. The managed connection 230 requires both the user's wireless mobile device to be proximate to the lock, i.e., within range of the short-range wireless interface, and another condition to exist, such as user action at a user interface or a timer elapsing. The managed connection 230 prevents the lock from being relocked immediately after being opened at state 228.

In the connected and unlocked state 232, an example of which is shown in FIG. 9C, the wireless mobile device and lock controller are wirelessly connected and capable of communication. The user may now manually close the lock, if necessitated by the mechanical features of the lock (e.g., a padlock) and command the lock to lock 234. If a disconnection 238 occurs, intentionally or otherwise, the disconnected and unlocked state 228 is entered.

The lock 234 command transitions to the connected and locked state 224. The user may now unlock 226 the lock again or disconnect 236, for example, by moving out of range of the lock or closing the application.

The lock 234 transition may trigger the transmission of a lock-access log to a server. Alternatively, arrival at the connected and locked state 224 may trigger the transmission of a lock-access log to a server.

In view of the above, it should be apparent that an electronic lock controller may use a secondary subsystem to connect to a long-range low-power network, which may include the internet, so as to interact with a server to store logs and receive requests to open the lock. The secondary subsystem is isolated from a primary subsystem that controls the lock. Further described herein is a lock that cannot be relocked without reconnection to a smartphone and a user interface that instructs and encourages users to return to the lock prior to leaving the location of the protected asset. This helps ensure that the lock is relocked when leaving the site and helps ensure the capture of complete lock-access logs.

While the foregoing provides certain non-limiting examples, it should be understood that combinations, subsets, and variations of the foregoing are contemplated. The monopoly sought is defined by the claims.

We claim:

1. A device comprising:
a lock control interface operably connectable to an electrical actuator of a lock that restricts access to a physical resource;
a primary wireless interface configured for communication with a wireless mobile device within a local vicinity of the primary wireless interface;
a primary processor connected to the primary wireless interface and the lock control interface, the primary processor configured to control the electrical actuator through the lock control interface to unlock the lock based on communication of cryptographic access data with the wireless mobile device via the primary wireless interface;
a secondary wireless interface configured for communication with a server via a long-range low-power wireless network; and
a secondary processor connected to the secondary wireless interface, the secondary processor configured to communicate with the server using the secondary wireless interface;
wherein the secondary processor is not operably connected to lock control interface.

2. The device of claim 1, wherein the secondary processor is connected to the primary processor and is configured to transmit a request to unlock the lock to the primary processor.

3. The device of claim 2, wherein the primary processor is configured to control the electrical actuator through the lock control interface to unlock the lock based on the request after validating an authenticity of the request.

4. The device of claim 3, wherein the secondary processor is configured to:
transmit a notification to the server via the long-range low-power wireless network using the secondary wireless interface, the notification being indicative of the wireless mobile device being within a local vicinity of the primary wireless interface;
in response to the notification, receive an authorization from the server via the long-range low-power wireless network using the secondary wireless interface; and
in response to the authorization, transmit the request to unlock the lock to the primary processor.

5. The device of claim 1, wherein:
the primary processor is configured to generate a lock-access log of instances of control of the electrical actuator through the lock control interface by the primary processor; and
the secondary processor is configured to communicate the lock-access log directly to the server via the long-range low-power wireless network using the secondary wireless interface.

6. The device of claim 5, wherein the secondary processor is configured to communicate the lock-access log directly to the server according to a condition, wherein the condition includes an age of the lock-access log, a battery life of the device, or a combination of such.

7. The device of claim 1, wherein the secondary processor is configured to block incoming communications through the long-range low-power wireless network from reaching the primary processor.

8. A device comprising:
a lock control interface operably connectable to an electrical actuator of a lock that restricts access to a physical resource;
a primary wireless interface configured for communication with a wireless mobile device within a local vicinity of the primary wireless interface;
a primary processor connected to the primary wireless interface and the lock control interface;
a secondary wireless interface configured for communication with a server via a long-range low-power wireless network; and
a secondary processor connected to the secondary wireless interface, the secondary processor configured for communication with the server using the secondary wireless interface, wherein the secondary processor is not operably connected to lock control interface;
wherein the primary processor is configured to control the electrical actuator through the lock control interface to unlock the lock based on communication of cryptographic access data.

9. The device of claim 8, wherein:
the secondary processor is configured to communicate remote cryptographic access data with the server and provide a corresponding request to unlock the lock to the primary processor; and
the primary processor is configured to unlock the lock in response to the request in conjunction with successful communication of local cryptographic access data with the wireless mobile device via the primary wireless interface.

10. The device of claim 8, wherein:
the primary processor is configured to unlock the lock in response to successful communication of local cryptographic access data with the wireless mobile device via the primary wireless interface; and
the secondary processor is configured to communicate a lock-access log to the server, the lock-access log indicative of unlocking of the lock in response to the successful communication of the local cryptographic access data.

11. The device of claim 8, wherein:
the secondary processor is configured to communicate remote cryptographic access data with the server and provide a corresponding request to unlock the lock to the primary processor; and
the primary processor is configured to unlock the lock in response to the request.
